(19) United States
(12) Patent Application Publication
(10) Pub. No.: US 2017/0028691 A1
(43) Pub. Date: Feb. 2, 2017

(54) METHOD FOR THERMALLY INSULATING AND SOUND-PROOFING COMPONENTS

(71) Applicant: Henkel AG & Co. KGaA, Duesseldorf (DE)

(72) Inventors: Jozef Hudina, Ketsch (DE); Josef Giesinger, Eppelheim (DE)

(21) Appl. No.: 15/292,722

(22) Filed: Oct. 13, 2016

Related U.S. Application Data
(63) Continuation of application No. PCT/EP2015/058007, filed on Apr. 14, 2015.

(30) Foreign Application Priority Data
Apr. 15, 2014 (DE) 102014207161.5

(51) Int. Cl. B32B 27/32; B32B 27/06; B32B 27/20; G10K 11/168; B32B 27/34; B32B 37/15; C08J 9/36; B32B 5/18; B32B 27/30

(52) U.S. Cl. CPC B32B 27/32; B32B 5/18; B32B 27/065; B32B 27/20; B32B 27/306; B32B 27/34; B32B 37/153; C08J 9/365; G10K 11/168; B32B 2305/022; B32B 2307/102; B32B 2509/00; C08J 2323/12; C08J 2423/12

(57) ABSTRACT

Disclosed is a method for sound-proofing and/or sound-insulating metal and/or plastic components, wherein an insulating layer made of an expanded first thermoplastic polymer material is applied to the components in a first step of the method, and a mass damping layer made of a second thermoplastic polymer material having a density of from 1.5 to 5 g/cm³ then is applied to the insulating layer.

The present invention relates to a method for thermally insulating and sound-proofing and/or sound-insulating metal and/or plastics components.

When producing modern appliances, apparatuses and machines, very thin-walled metal sheets or plastics components are used almost exclusively nowadays. Mechanically moving parts, washing and rinsing cycles or running motors inevitably cause these thin-walled metal sheets or plastics components to vibrate, in many cases in the audible range of the human ear. These vibrations are transmitted in the form of structure-borne sound over the entire machine, the apparatus or the appliance and can be radiated through the air to remote points in the form of disturbing sound. In order to attenuate the sound radiation and to damp structure-borne sound, these metal sheets or plastics components are therefore provided, for example in automotive manufacture or during the manufacture of household appliances, with sound-proofing coverings, known as anti-drumming coatings.

According to the conventional method, mixtures consisting of fillers having a high specific weight and bitumen are extruded to form (asphalt) films, from which the corresponding molded parts can then be punched or cut. These films are then bonded to the relevant sheet metal parts, it possibly being necessary to adapt them to the shape of the metal sheet by heating.

It is prior art, in particular for “white goods”, i.e. domestic appliances or domestic machines such as dishwashers and washing machines, to acoustically dampen said goods using a heavy-gauge asphalt film in order to improve the noise behavior. For this purpose, a pre-made heavy-gauge asphalt film is generally fused or bonded to the outer surfaces of the appliance. The appliance container mainly consists in these cases of thin stainless steel sheet having a typical thickness of approximately 0.4 mm.

In this case, the heavy-gauge film is applied, in particular, to increase the mass of the container wall. This procedure is generally referred to as “mass damping” and generally improves the acoustic properties of the appliance. Without such a measure, the often very thin-walled metal sheet acting as a resonating body would be made to vibrate, for example by the constant water jet pulse of a dishwasher, on the inner side of the washing container, and the appliance would become a very disruptive source of noise in the household.

In addition to energy consumption and the quality of the rinsing or washing properties, the acoustic behavior of such appliances is, however, one of the main distinguishing features of individual products on the market.

As derivatives of heavy oil, bitumen-based materials do not belong to the preferred substances used in regions where food is stored and prepared, as is the case in a domestic kitchen. However, conventional mass damping using heavy-gauge asphalt films is also used for want of cost-effective alternatives. An additional disadvantage of the asphalt films in that such heavy-gauge films are very good heat conductors and thus lead to increased heat losses.

Therefore, the object of the present invention was to provide a new method which makes it possible to carry out acoustic mass damping, in particular of domestic appliances such as dishwashers, without using bitumen.

It has now been found that this object can be achieved by a method in which, instead of an heavy-gauge asphalt film, a piece of multi-layer insulation based on food-safe polypropylene materials is used, the piece of multi-layer insulation having both a thermal insulating layer that is applied directly to the appliance and is made of an expanded polypropylene foam, and a layer made of highly filled polypropylene placed thereon.

These insulating layers have several advantages over the asphalt films used thus far. On the one hand they are, as already mentioned, toxicologically safe. Furthermore, in addition to mass damping comparable to that achievable using heavy-gauge asphalt films, they provide thermal insulation, which minimizes energy loss. Lastly, they also provide improved flame protection. In addition, the construction according to the invention improves the adherence of the mass damping material to the component.

A first aspect of the invention relates to a method for sound-proofing and/or sound-insulating metal and/or plastics components, an insulating layer made of an expanded first thermoplastic polymer material being applied to the components in a first step of the method, and a mass damping layer made of a second thermoplastic polymer material having a density of from 1.5 to 5 g/cm³ then being applied to the insulating layer as a defined profile by means of direct extrusion at melting temperatures of between 120 and 300° C.

Metal components are preferably thin-walled sheets of steel, aluminum and in particular stainless steel. Plastics components can, for example, be made of thin-walled PVC polymers, polycarbonate polymers, polypropylene polymers, acrylonitrile butadiene styrene polymers (ABS polymers) or glass-fiber-reinforced plastics materials (FRP).

Said components to be coated are preferably component parts of “white goods”, i.e. domestic appliances or domestic machines such as dishwashers and washing machines, or of bath tubs, shower bases, shower trays or sinks. However, they can also be component parts of data processing devices (computers), pump housings, compressors, agricultural vehicles and devices, medical devices or housing turrets of wind turbines.

In various embodiments, the coated components are the housing or washing body of a dishwasher or washing machine, in particular a dishwasher. Housings or washing bodies of this type usually consist of a stainless steel sheet or, in some cases, of polypropylene.

Thermoplastic polymer materials within the context of this invention are thermoplastic polymers of the same type, with which fillers, optionally reinforcing materials and/or other additives, have also been admixed. Examples of thermoplastic polymers to be used are vinyl polymers, in particular ethylene vinyl acetate (EVA), polyolefins, such as polypropylene and polyethylene, polyamides (PA), polyesters, polyacetates, polycarbonates, polyurethanes and ionomers. None of the thermoplastic polymers within the context of the present invention is bitumen. The polymer materials used in this case are preferably free of bitumen. The polymer preferably used in the described method is polypropylene.

The thermoplastic polymer material used as the insulating layer is an expanded material. In this case, expanded films consisting of thermoplastic polymers, in particular polypropylene, are particularly preferred. Expanded films of this type can have a thickness in the range of from 1 to 10 mm, the thickness preferably being in the range of from 2 to 5 mm.

These expanded films are applied to the components and are preferably bonded thereto. These expanded films are particularly preferably applied to the components by means of blow molding.

The insulating layer can be applied by all the surfaces of a component, for example a washing container, being coated. Alternatively, said layer can be applied to only parts of the component. Likewise, the mass damping layer can be applied to all the surfaces of a component, in particular to all the surfaces that have already been coated with the insulating layer. Alternatively, however, the mass damping layer can also be applied to only parts of the surfaces of the component, in particular parts of the surfaces of the component that are coated with an insulating layer. In certain embodiments, at points where additional material for mass damping, i.e. the mass damping layer, has been applied, the insulating layer can be compressed and flattened, for example using pressing elements such as press rollers. This gives the coating a uniform thickness. For example, a 4 mm-thick expanded film can be compressed to 1 mm at the points at which the mass damping layer has been applied, and the mass damping layer can then be applied to a thickness of 3 mm such that the whole component is provided with a 4 mm-thick coating.

The overall thickness of the layer on the component is, in different embodiments, from 3 to 6 mm, preferably approximately 4 mm. In this case, the expanded film can have the desired thickness of from 3 to 6 mm, preferably 4 mm, outside the region covered with the mass damping layer, and in regions in which a mass damping layer has been applied, the expanded film is compressed beforehand to such a thickness that, after the application of the mass damping layer typically to a thickness of from 2 to 5 mm, preferably 3 mm, the desired overall thickness of from 3 to 6 mm, preferably 4 mm, is obtained, i.e. compression to a thickness of 1 mm can take place for example.

The second thermoplastic polymer material used as the mass damping layer can likewise contain one of the above-mentioned polymers. In order to achieve a high density of the thermoplastic polymer material, said polymer material should be highly filled, i.e. have a filler content of at least 60 wt. % based on the polymer material.

Inorganic salts or oxides, preferably those having a high density of between 2.5 and approximately 12 g/cm³ are used as fillers. Examples of such fillers are zinc oxide (ZnO), tin dioxide (SnO₂), titanium dioxide (titanium (IV) oxide, TiO₂), iron oxide—in particular iron(II) oxide (FeO), iron (III) oxide (iron sesquioxide Fe₂O₃), iron (II,III) oxide (ferrous-ferric oxide Fe₃O₄, magnetite), barium sulfate (BaSO₄), lead sulfate (lead vitriol, PbSO₄), aluminum hydroxide (e.g. in the form of hydrargillite, bayerite, nordstrandite) or aluminum metahydroxide (e.g. in the form of disaspore or boehmite), hafnium boride, hafnium carbide, hafnium nitride, hafnium dioxide (HfO₂), tungsten oxides (e.g. tri-tungsten oxide (W₃O), tungsten dioxide (tungsten (IV) oxide, WO₂), tungsten trioxide (tungsten (VI) oxide, WO₃)), rhenium dioxide (ReO₂), rhenium trioxide (ReO₃) and rhenium heptoxide (Re₂O₇).

Another possibility is that of using the corresponding rock flours or ore meals as the filler. Examples thereof are dolomite, cassiterite (tin ore, SnO₂), bismuth blend (eulytine, eulytite, Bi₄[SiO₄]₃), bismuth glance (bismuthinite, bismuthine, Bi₂S₃), ilmenite (titanium iron, FeTiO₃) and granite stone flour.

The use of barite, iron oxides, aluminum hydroxides or mixtures thereof is very particularly preferred.

A particularly preferred embodiment contains calcium carbonate as the filler, which can be used either on its own or mixed with the other fillers.

The fillers to be used have a grain size range of between 0.01 and 5000 μm, preferably of between 0.1 and 100 μm, particularly preferably between 0.5 and 20 μm.

The density of the highly filled thermoplastic polymer materials used is generally in the range of from 1.5 to 5 g/cm³, preferably in the range of from 2.1 to 4.5 g/cm³.

In various embodiments, temperatures in the range of from 180 to 250° C. are used when extruding the second thermoplastic polymer material.

The thickness of the mass damping layer made of the second thermoplastic polymer material is usually from 1 to 10 mm, preferably approximately from 2 to 5 mm.

The highly filled polymer material is preferably used in granular form. The granules (also referred to as pellets) can have a grain diameter of from 0.5 mm to 30 mm, preferably from 2 to 10 mm. In this case, the grain size can be determined by sieve analysis, for example. The grain is preferably spherical or lens-shaped, but it can also be elliptical or cylindrical. The surface of the granulate particles should preferably be adhesive- and block-free in order to prevent the granulate bonding to larger aggregates during storage and transport.

The polymer materials used can also contain auxiliary agents known per se.

The mass damping layer is applied by means of direct extrusion (DEX). This increases the degree of freedom of the device manufacturer, since pre-made heavy-gauge films no longer need to be used. Instead, the position and layer thickness of the coating can be selected and set in a freely programmable manner.

The usable thermoplastic material can be fed to the extruder by means of gravity or pneumatic conveyor systems. Pneumatic conveyor systems are understood to be vacuum and/or blow conveyors in this context.

In this case, the thermoplastic material and/or additional auxiliary agents are preferably fed by means of continuous gravimetric or volumetric metering such that, depending on the application, a defined profile having constant or predefined variable dimensions is directly applied to the substrate to be coated, which may be pre-heated, from the extruder. Alternatively, precise amounts of the individual material components can be fed to the extruder.

It is preferable for the insulating layer and the mass damping layer to have the same polymer base, i.e. for both to consist of polypropylene materials, for example. As a result, during the direct extrusion of the second polymer material, both layers are welded and do not have to be bonded. Although welding of this kind is preferable, in alternative embodiments methods can also be used in which the two layers are bonded. For this purpose, a hot-melt adhesive can be admixed with the second polymer material and/or the component can be coated with a hot-melt adhesive of this kind. Suitable hot-melt adhesives are known in the art.

According to a particularly preferred embodiment, the insulating layer and/or the mass damping layer, preferably at least the insulating layer, in particular only the insulating layer, contain hollow microbeads, in particular selected from glass, plastics or ceramic hollow microbeads, in particular ceramic hollow microbeads or glass hollow microbeads, preferably ceramic hollow microbeads and/or glass hollow microbeads based on silicate/aluminate glasses or ceramics. By using hollow microbeads, in particular in the insulating layer, the thermal insulation and the material properties can be improved further. Plastics hollow balls made of, for example, polyethylene, polypropylene, polyurethane, polystyrene or a mixture thereof, can be used as the organic hollow microbeads, for example. The mineral hollow microbeads can, for example, contain clay, aluminum silicate, glass or mixtures thereof. In particular, the organic or mineral hollow microbeads have a diameter of from 1 to 1000 μm, preferably from 5 to 200 μm. The hollow microbeads can have a vacuum or partial vacuum in the interior thereof or can be filled with air, inert gases, for example nitrogen, helium or argon, or reactive gases, for example oxygen. Preferably, glass hollow microbeads are used as the hollow microbeads. In a particularly preferred embodiment, the hollow microbeads have a compressive strength of at least 50 bar, in particular at least 100 bar, preferably 130 bar. Hollow microbeads that are preferably used according to the invention have a Mohs hardness of at least 4, in particular at least 4.5, particularly preferably at least 5. Hollow microbeads that are preferred according to the invention have a shell diameter which only makes up approximately 5 to 15%, preferably only approximately 10%, of the overall beads (i.e. in other words, approximately 85% to 95%, preferably approximately 90%, of the beads are made up of the cavity). For example, 3M Scotchlite glass bubbles can be used as the glass hollow microbeads or are commercially available from Omega Minerals Germany GmbH, Norderstedt, under the product name “ISOSPHERES SG-300-B”.

Prior to the coating step, the substrate can be pre-heated to a defined temperature in this case by means of infrared radiation, laser radiation, a supply of hot air or, for metal substrates, can also be pre-heated inductively. Inductive pre-heating can in particular be carried out dynamically, i.e. a sensor determines the substrate temperature, which is then compared with a predefined target value in order to determine and set the required heating capacity of the induction heater therefrom. Corresponding pre-heating apparatuses are preferably attached either directly to the extruder head or directly upstream thereof, so that pre-heating takes place shortly before coating.

In order to coat the substrate, the component to be coated and the extruder head, together with the nozzle mounted thereon, have to move relative to one another. In this case, in order to generate the relative movement, the following can be carried out:
the component stays still and the nozzle moves, or
both the component and the nozzle move, or
the nozzle is stationary and the component moves.

The relative movement is preferably generated by manipulators. Within the context of this invention, manipulators are devices which allow for physical interaction with the surroundings. In this case, this is the movable part of the structure which carries out the mechanical work of the extruder head.

In the case of the moving nozzle, the manipulator used can be a robot having 5 or 6 rotation axes or displacement axes (rotary or translational axes), as a result of which the individual movements can be combined to form an overall movement.

In this case, the robot can carry the extruder, together with the pre-heating apparatus, and can carry out the relative movement. Similar robots are described for example in U.S. Pat. No. 5,358,397, EP 0787576 B1 and DE 10137214 A1.

When both the component and the extruder nozzle move, the manipulator is preferably fixedly arranged next to a conveyor belt, the manipulator only moving the extruder mounted thereon or the extruder nozzle along two axes that are orthogonal to one another. The component to be coated is horizontally guided past the manipulator station on a conveyor apparatus, said conveyor apparatus optionally being provided with guide apparatuses, transversely to the transport direction, which control the start and finish of the extrusion process of the coating material.

If the nozzle is arranged such that it cannot move, the component to be coated is guided past the nozzle of the extruder by means of a suitable robot. The robot has from 2 to 6 rotation and displacement axes, depending on the shape and size of the component to be coated.

Both the conveyor apparatus and the coating station are specifically designed according to the size and shape of the components to be coated. If the component to be coated is a complete washing container of a washing machine, a dishwasher or a housing turret for example, the design of the conveyor apparatuses for feeding the components to the coating station has to be adapted to the components. The manipulator or robot carrying out the coating also has to have a corresponding design. Apparatuses of this type are already known in the automotive industry, for example.

1. A method for sound-proofing and/or sound-insulating components, comprising steps of:
i) applying an insulating layer made of an expanded first thermoplastic polymer material to at least one surface of a component;
ii) applying a mass damping layer made of a second thermoplastic polymer material having a density of from 1.5 to 5 g/cm³ to the insulating layer as a defined profile by means of direct extrusion at melting temperatures of between 120 and 300° C.

2. The method according to claim 1, wherein the component is used for domestic appliances or domestic machines or is a component part of a domestic appliance or domestic machine.

3. The method according to claim 1, wherein the component is a sink, bath tub, shower base or shower tray.

4. The method according to claim 1, wherein the component comprises substrates to be coated made of at least one of stainless steel, PVC polymers, polycarbonate polymers, polypropylene polymers, acrylonitrile butadiene styrene polymers (ABS polymers) or glass-fiber-reinforced plastics materials (FRP).

5. The method according to claim 1 wherein the first thermoplastic polymer material is an expanded film.

6. The method according to claim 5 wherein the expanded film is an expanded polypropylene film.

7. The method according to claim 1 wherein the first thermoplastic polymer material is applied to the component by means of blow molding and is bonded.

8. The method according to claim 1 wherein the second thermoplastic polymer material is a polypropylene (PP), ethylene vinyl acetate (EVA) or polyamide comprising inorganic salts as fillers.

9. The method according to claim 1 wherein the second thermoplastic polymer material comprises polypropylene (PP) and has a filler content of at least 60 wt. % based on the polymer material.

10. The method according to claim 8, wherein the inorganic salts are selected from barium sulfate, aluminum hydroxide, iron oxides and combinations thereof.

11. The method according to claim 8, wherein the second thermoplastic polymer material has a density of between 2.1 and 4.5 g/cm³.

12. The method according to claim 1, wherein the second thermoplastic polymer material is applied at a temperature of between 180 and 250° C.

13. The method according to claim 1, wherein the second thermoplastic polymer material is in granular form prior to being heated.

14. The method according to claim 1, wherein the insulating layer and/or mass damping layer contains hollow microbeads.

15. A sound-proofed and/or sound-insulated component, obtained by a method according to claim 1.

16. The sound-proofed and/or sound-insulated component according to claim 15, wherein the component is part of a domestic appliance or domestic machine.

17. The sound-proofed and/or sound-insulated component according to claim 15, wherein the component is a sink, bath tub, shower base or shower tray.
